(19) United States
(12) Patent Application Publication
(10) Pub. No.: US 2013/0238984 A1
(43) Pub. Date: Sep. 12, 2013

(54) DISPLAY CONTROL DEVICE, DISPLAY CONTROL METHOD, AND COMPUTER PROGRAM PRODUCT

(71) Applicant: Atsushi OKAZATO, Kanagawa (JP)

(72) Inventor: Atsushi OKAZATO, Kanagawa (JP)

(73) Assignee: Ricoh Company, Limited, Tokyo (JP)

(21) Appl. No.: 13/784,945

(22) Filed: Mar. 5, 2013

(30) Foreign Application Priority Data
Mar. 7, 2012 (JP) 2012-050945

(51) Int. Cl. G06F 17/21

(52) U.S. Cl. CPC G06F 17/211
USPC 715/238

(57) ABSTRACT

In an embodiment, provided is a display control device that includes: an acquiring unit that acquires a request for display of display information regarding an apparatus on a display screen; an operation item determining unit that determines, based on a type of the display information, a kind of an operation item that receives user operation while the display information is displayed; an arrangement determining unit that determines, based on the kind of the operation item, arrangement positions of an operation area in which the operation item is displayed and a display area in which the display information is displayed in the display screen; a size determining unit that determines, based on the arrangement positions and a screen size of the display screen, sizes of the operation area and the display area; and a display information generating unit that generates display information including the operation area and the display area.

### CROSS-REFERENCE TO RELATED APPLICATIONS

The present application claims priority to and incorporates by reference the entire contents of Japanese Patent Application No. 2012-050945 filed in Japan on Mar. 7, 2012.

### BACKGROUND OF THE INVENTION

1. Field of the Invention

The present invention relates to a display control device, a display control method, and a computer program product.

2. Description of the Related Art

Conventional web browsers are installed in apparatuses with different display screen sizes, such as a personal computer (PC), a smartphone, and a tablet terminal, so as to display web pages on a display screen of each of the apparatuses. It is possible, with user operation, to change a window size (screen size) of a web page displayed by the web browser on a display screen of a PC. The font size of letters contained in a web page, etc. is set to be various values according to a kind of the web browser; and the setting can be changed with user operation.

Thus, the layout of a web page is changed depending on a display environment (display screen size), and a web page in layout not intended by a creator thereof is possibly provided to a user. Therefore, it is desired to form a web page so that it is displayed in layout intended by a creator thereof regardless of a display environment.

As a technique for forming a web page exhibiting same appearance regardless of a display environment, there are known layout methods such as a “fixed width layout” and a “liquid layout”. Moreover, there is known a technique in which, when a web page formed for PC is displayed on a display screen whose size is relatively small, such as of a smartphone and a tablet terminal, the entire size of the web page for PC is reduced, and the reduced web page is displayed.

However, when the screen size of a web page is smaller than a size assumed by a creator of the web page, the fixed width layout involves a problem of significantly deteriorating usability because vertical and horizontal scroll bars are displayed.

In the case of liquid layout, the sizes of arrangement areas of texts, icons, etc. are changed depending on a screen size. This causes a problem that a web page in layout intended by a creator thereof is not displayed.

Moreover, when the entire size of a web page is reduced because the original size thereof does not fit into a browser screen, the sizes of letters, icons, etc. become smaller, which causes a problem of making it difficult for a user to read the letters or push buttons, for example.

In the portable device such as a smartphone, a case may occur in which a web page deteriorated in operability and visibility, such as a web page generated with the above-mentioned layout methods and a web page reduced in entire size, is displayed. In such cases, in general, a part that a user desires to view or operate is displayed in a display screen with enlarging operation or moving operation such as scrolling made by the user.

However, when a web page is displayed on an operation display panel of a printer, for example, it is not preferable to require user operation same as in the case of a smartphone, etc., and the display of a web page excellent in operability and visibility is desired.

Then, Japanese Patent Application Laid-open No. 2010-277120 discloses a technique in which, in order to display a web page for PC on an operation display panel, when the web page stored in a server outside of an apparatus is to be displayed with a web browser in the operation display panel, the web browser analyzes the web page, and HyperText Markup Language (HTML), Cascadeing Style Sheet (CSS), and JavaScript (registered trademark) are dynamically generated so as to form a web page appropriate for display on the operation display panel.

An apparatus having a device configuration such as of an operation panel of a multifunction peripheral (MFP) normally involves operation employing the combination of a touch panel and a hard key. In operation of such a device, an area for notifying a user of information (display area) and an area for receiving input operation to a screen (operation area) made by a user are generally displayed in the web browser.

However, the size and the layout of the operation area are preliminarily determined depending on the kind of an operation item arranged in the operation area; and in accordance with them, the size and the layout of the display area are determined. Therefore, when there are many items to be displayed in the display area, there occur a problem that all of the items cannot be displayed in the display area because the display area is too small, and a problem that the visibility is deteriorated because the sizes of the items become too small.

There is a need to provide a display control device, a display control method, and a computer program product that allow the display of display information excellent in operability and visibility on a display device regardless of a screen size of the display device.

### SUMMARY OF THE INVENTION

It is an object of the present invention to at least partially solve the problems in the conventional technology.

According to an embodiment, provided is a display control device that includes: an acquiring unit that acquires a request for display of display information regarding an apparatus on a display screen; an operation item determining unit that determines, based on a type of the display information, a kind of an operation item that receives user operation while the display information is displayed; an arrangement determining unit that determines, based on the determined kind of the operation item, arrangement positions of an operation area in which the operation item is displayed and a display area in which the display information is displayed in the display screen; a size determining unit that determines, based on the arrangement positions and a screen size of the display screen, sizes of the operation area and the display area; and a display information generating unit that generates display information including the operation area and the display area having the sizes determined.

According to another embodiment, provided is a display control method performed by a display control device. The display control method includes: acquiring a request for display of display information regarding an apparatus on a display screen; determining, based on a type of the display information, a kind of an operation item that receives user operation while the display information is displayed; determining, based on the determined kind of the operation item, arrangement positions of an operation area in which the operation item is displayed and a display area in which the display information is displayed in the display screen; determining, based on the arrangement positions and a screen size of the display screen, sizes of the operation area and the display area; and generating display information including the operation area and the display area having the sizes determined.

According to still another embodiment, provided is a computer program product that includes a non-transitory usable medium having computer-readable program codes embodied in the medium for display control in a display control device, the program codes when executed causing the display control device to execute: the display control method described above.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an entire configuration of an image forming system of a first embodiment;

FIG. 2 is a diagram illustrating a page for independent scaling;

FIG. 3 is a diagram illustrating a page for document storage;

FIG. 4 is a diagram schematically illustrating a data configuration of a rule table stored by a storage unit;

FIG. 5 is a diagram illustrating an area layout “pattern 1”;

FIG. 6 is a diagram illustrating an area layout “pattern 2”;

FIG. 7 is a sequence diagram illustrating processing of the image formation system;

FIG. 8 is a sequence diagram illustrating processing of the image formation system;

FIG. 9A is a diagram illustrating an HTTP request transmitted from a web browser at S100;

FIG. 9B is a diagram illustrating a screen size confirmation page sent back to the web browser at S104;

FIG. 10 is a diagram illustrating a request transmitted from the web browser at S106;

FIG. 11A is a diagram illustrating a request transmitted from the web browser at S117;

FIG. 11B is a diagram illustrating an example of CSS file data for web page sent back to the web browser at S128;

FIG. 12A is a diagram illustrating a request transmitted from the web browser at S129;

FIG. 12B is a diagram illustrating a JavaScript file for web page sent back to the web browser at Step S135;

FIG. 13 is a flowchart illustrating specific processing of a CSS file generating unit in CSS file generation processing (Step S126);

FIG. 14A is a diagram illustrating an example of the layout of a CSS file generated at S204;

FIG. 14B is a diagram illustrating an example of the layout of the CSS file after size recalculation;

FIG. 15 is a diagram illustrating another example of the layout of the CSS file generated at S204;

FIG. 16 is a diagram illustrating an entire configuration of an image forming system of a second embodiment; and

FIG. 17 is a diagram illustrating an example of HTML data generated by a copy page generating unit of an image forming apparatus.

### DETAILED DESCRIPTION OF THE PREFERRED EMBODIMENTS

in the following, embodiments of a display control device, display control method, and a computer program product are described in detail with reference to the enclosed drawings.

### First Embodiment

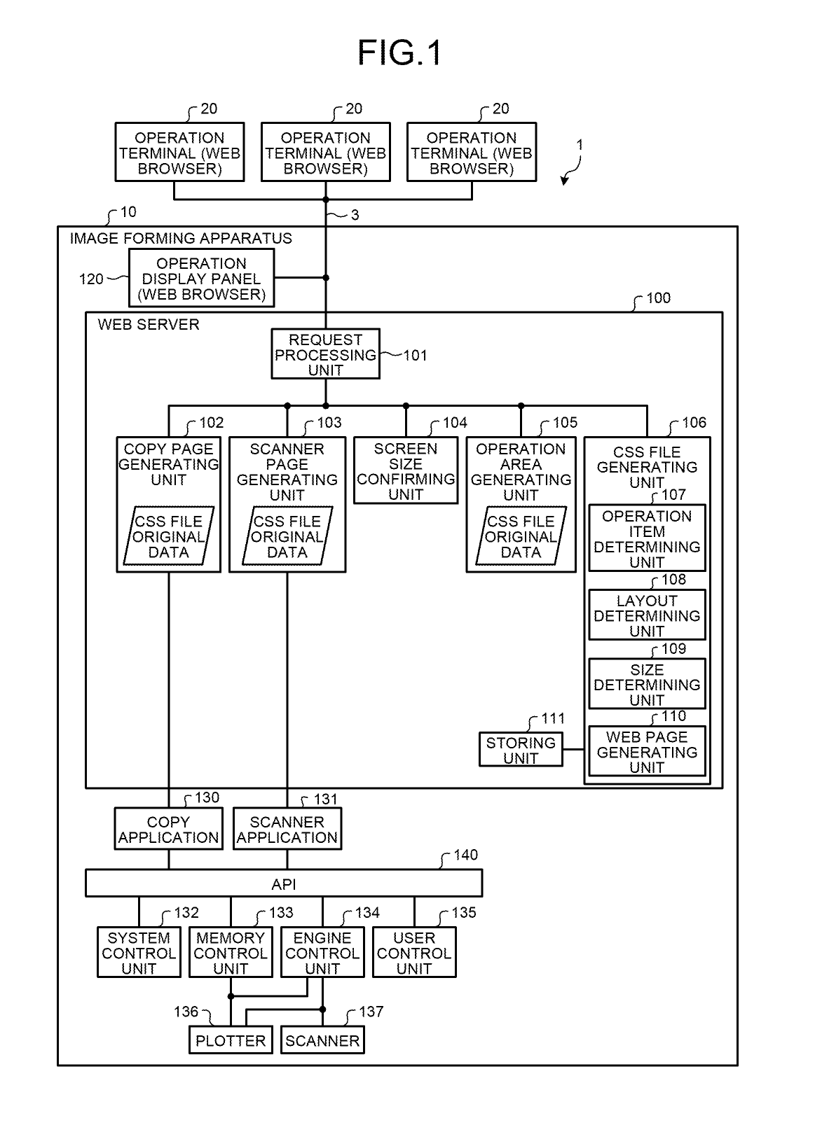

FIG. 1 is a diagram illustrating an entire configuration of an image forming system 1 of a first embodiment. The image forming system 1 has an image forming apparatus 10, and three operation terminals 20 connected to the image forming apparatus 10 through a network 3. The operation terminal 20 is exemplified by a PC, a smartphone, a tablet terminal, etc. The number of the operation terminals 20 in the image forming system 1 is not limited to a specific number described in the embodiment. The image forming system 1 may have one or two operation terminals, or may have four or more operation terminals.

The image forming apparatus 10 has a web server 100, an operation display panel 120, a copy application 130, a scanner application 131, a system control unit 132, a memory control unit 133, an engine control unit 134, a user control unit 135, a plotter 136, a scanner 137, and an application program interface (API) 140.

Receiving a web page display request from an apparatus having a web browser function, the web server 100 generates a web page of the display request, and transmits the generated web page to the apparatus as a sender of the display request. The web server 100 generates a web page regarding an application (copy application 130 and scanner application 131) installed in the image forming apparatus 10, for example.

In the image forming system 1, the operation terminal 20 and the operation display panel 120 have a web browser function. The operation terminal 20 and the operation display panel 120 transmit requests for display of various web pages to the web server 100. In addition, the operation terminals 20 and the operation display panel 120 receive web pages from the web server 100 as a response to the display request, and display the web pages on the display screen.

The operation display panel 120 has a liquid crystal display (LCD) for displaying web pages, a light-emitting diode (LED) or a buzzer for indicating the operating state of the image forming apparatus 10, a plurality of hard keys for receiving user operation, etc. (any of which is not illustrated). In the image forming apparatus 10, the operation display panel 120 is connected to the web server 100 through the network 3, similarly to the operation terminals 20.

The copy application 130 and the scanner application 131 are applications installed in the image forming apparatus 10. The copy application 130 performs copy job. The copy application 130 also provides information on itself including setting information set to the copy application 130 to the web server 100. The scanner application 131 performs scan job. The scanner application 131 also provides information thereof including setting information set to the scanner application 131 such as setting of the application to the web server 100. In the embodiment, the image forming apparatus 10 has the copy application 130 and the scanner application 131, as an example. However, the number and the kind of application installed in the image forming apparatus 10 are not limited to those described in the embodiment.

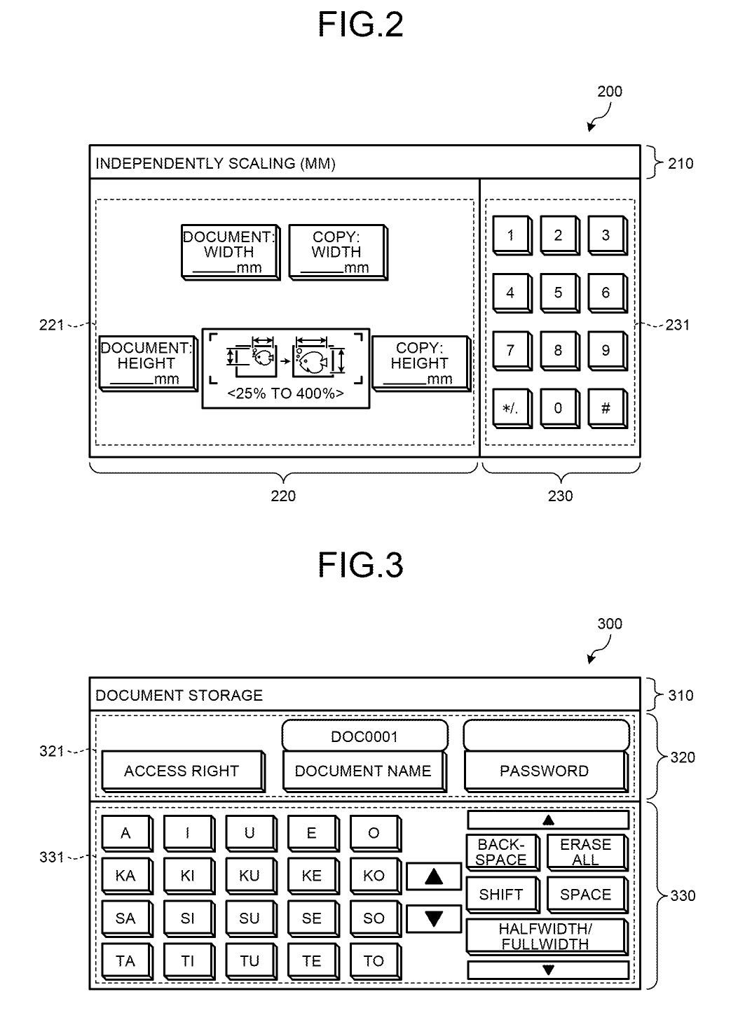

Here, a web page provided by the web server 100 is described with reference to FIG. 2 and FIG. 3. FIG. 2 is a diagram illustrating a page for independent scaling 200 that is a web page related to a scaling function. FIG. 3 is a diagram illustrating a page for document storage 300 that is a web page related to a document storage function. Both of the web pages are web pages related to the copy application 130.

In the page for independent scaling 200 illustrated in FIG. 2, a message area 210, a display area 220, and an operation area 230 are arranged. The message area 210 is an area in which the character string of a page title is arranged. The display area 220 is an area in which information to be notified to a viewer of a web page is displayed. In the display area 220 illustrated in FIG. 2, a plurality of items (item group 221) displaying the height and the width of a document, etc. are arranged. The operation area 230 is an area in which operation buttons for receiving operation by a user are arranged. In the operation area 230 illustrated in FIG. 2, a numeric keypad 231 for inputting the height of a document, etc. in the display area 220 is arranged.

In the page for document storage 300 illustrated in FIG. 3, a message area 310, a display area 320, an operation area 330 are arranged, similarly to the page for independent scaling 200. In the display area 320, a plurality of items (item group 321) displaying a document name, etc. are arranged. In the operation area 330, a keyboard 331 for inputting the document name, etc. in the display area 320 is arranged.

In this manner, although the page for independent scaling 200 and the page for document storage 300 both have a display area and an operation area, the size and the layout of such areas relative to an entire page are different. The web server 100 of the embodiment can change the relative size and layout of each area in a web page depending on the type of a web page.

Returning to FIG. 1, the web server 100 determines the size and the layout of each area of a web page in accordance with a screen size of the apparatus as a sender of the web page request, and generates a web page appropriate for the screen size determined.

The web server 100 has, as functions for achieving this, a request processing unit 101, a copy page generating unit 102, a scanner page generating unit 103, a screen size confirming unit 104, an operation area generating unit 105, a CSS file generating unit 106, and a storage unit 111.

The request processing unit 101 acquires, from the operation terminal 20 or the operation display panel 120, a request such as a display request input by a user on the operation terminal 20 or the operation display panel 120 serving as a web browser. That is, the request processing unit 101 serves as an acquiring unit. The request processing unit 101 refers to a uniform resource locator (URL) in the request, and instructs, depending on the URL, any of the copy page generating unit 102, the scanner page generating unit 103, the screen size confirming unit 104, the operation area generating unit 105, and the CSS file generating unit 106, which are sub-modules of the request processing unit 101, to perform processing in accordance with the request.

The copy page generating unit 102 generates HTML data as the web page of the copy application 130, and sends the generated HTML data back to the web browser (operation terminal 20 or operation display panel 120) through the request processing unit 101. When a user performs operation on the web page, the copy page generating unit 102 sends an instruction in accordance with the operation result to the copy application 130 so as to update display contents of the web page in accordance with the operation result. In addition, the copy page generating unit 102 has CSS file original data that is a template of a CSS file defining the layout of a web page for copy.

Similarly to the copy page generating unit 102, the scanner page generating unit 103 generates HTML data as a web page of the scanner application 131, and sends the generated HTML data back to the web browser through the request processing unit 101. When a user performs operation on the web page, the scanner page generating unit 103 sends an instruction in accordance with the operation result to the scanner application 131 so as to update display contents of the web page in accordance with the operation result. In addition, the scanner page generating unit 103 has CSS file original data that is a template of a CSS file defining the layout of a web page for scan.

Once the request processing unit 101 acquires the web page display request, the screen size confirming unit 104 confirms a screen size of the apparatus as a sender of the display request. The screen size confirming unit 104 sets the specified screen size in a cookie in the apparatus as a sender of the request through the request processing unit 101.

The operation area generating unit 105 has CSS file original data that is a template of a CSS file defining the layout of the operation area. The CSS file generating unit 106 acquires HTML data as a web page from the copy page generating unit 102 or the scanner page generating unit 103. In addition, the CSS file generating unit 106 refers to the screen size set in the cookie so as to generate a CSS file appropriate for the screen size based on a rule table stored in the storage unit 111 and the HTML data. The rule table is described later. The CSS file generating unit 106 transmits the generated CSS file to the web browser as a sender of the display request through the request processing unit 101.

The CSS file generating unit 106 has an operation item determining unit 107, a layout determining unit 108, a size determining unit 109, and a web page generating unit 110. The operation item determining unit 107 refers to the rule table stored in the storage unit 111 so as to determine, based on the type of a web page specified in the display request, an operation item necessary for the web page of the display request. Here, the operation item is an operation icon for receiving user operation. In the embodiment, the numeric keypad 231 illustrated in FIG. 2 or the keyboard 331 illustrated in FIG. 3 is specified as the operation item.

The layout determining unit 108 refers to the rule table so as to determine the arrangement positions of a display area and an operation area included in a web page, that is, the area layout of the web page. The size determining unit 109 refers to the rule table so as to determine the sizes of the display area and the operation area based on the screen size and the area layout determined by the layout determining unit 108. The web page generating unit 110 generates a web page based on the information determined by the operation item determining unit 107, the layout determining unit 108, and the size determining unit 109.

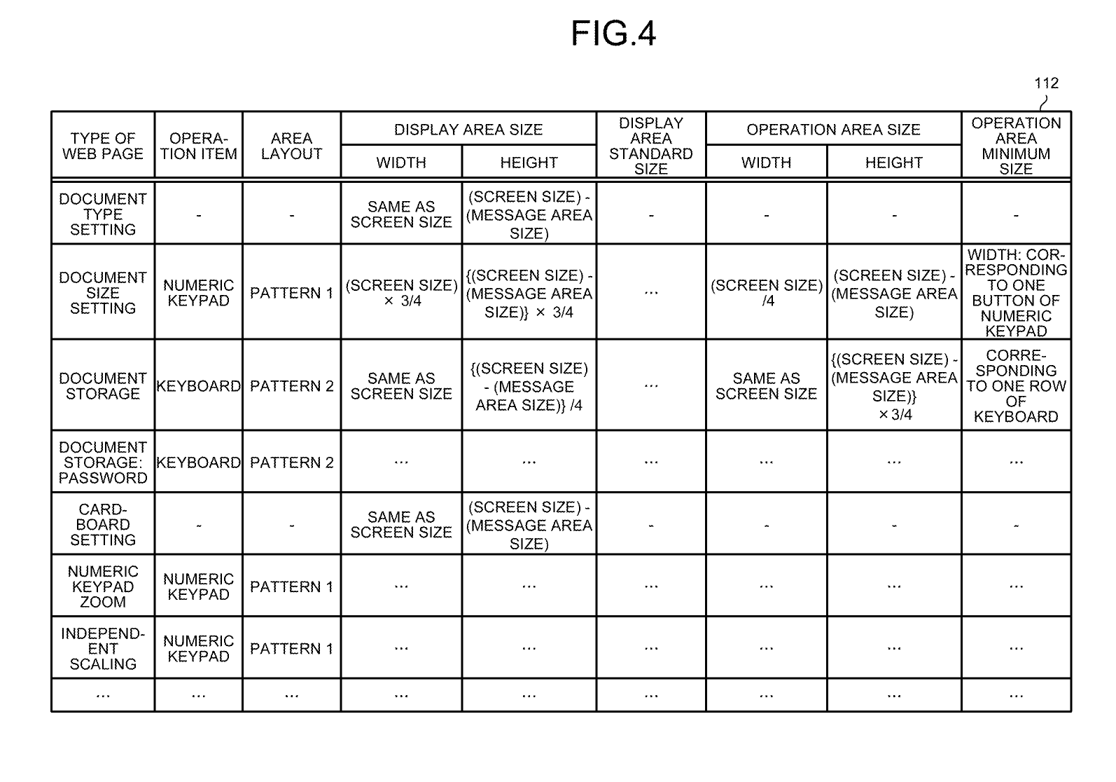

FIG. 4 is a diagram schematically illustrating a data configuration of a rule table 112 stored in the storage unit 111. The rule table 112 stores therein information for determining an operation item, an area layout, a display area size, and an operation area size based on the type of a web page. To be more specific, the rule table 112 stores therein a plurality of sets each composed of a type of a web page, an operation item, an area layout, a display area size, a display area standard size, an operation area size, and an operation area minimum size in an associated manner.

The operation item is an operation item necessary for user operation on the corresponding web page. That is, the kind of the operation item is defined by the type of a web page. The area layout is defined by the kind of an operation item. In the rule table illustrated in FIG. 4, the area layout “pattern 1” is defined corresponding to the numeric keypad, and the area layout “pattern 2” is defined corresponding to the keyboard.

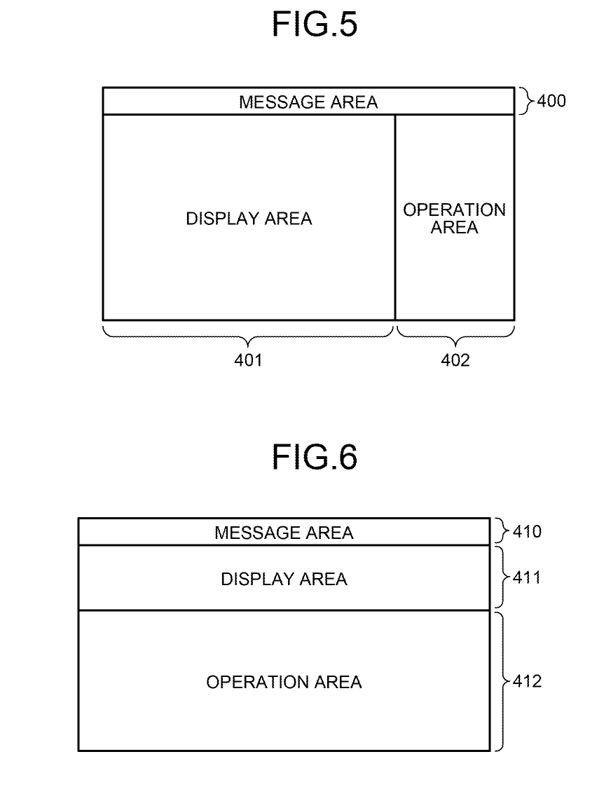

FIG. 5 is a diagram illustrating the area layout “pattern 1”. In the area layout “pattern 1”, a display area 401 and an operation area 402 are arranged laterally under a message area 400.

FIG. 6 is a diagram illustrating the area layout “pattern 2”. In the area layout “pattern 2”, a display area 411 and an operation area 412 are arranged vertically under a message area 410.

The numeric keypad buttons are generally arranged in a vertically-long rectangular area. Then, the area layout “pattern 1” is applied to the operation item of the numeric keypad, and the display area and the operation area are arranged laterally in the display screen, so that a user can operate the numeric keypad buttons without feeling discomfort.

By contrast, the keyboard is generally arranged in a laterally-long rectangular area. Then, the area layout “pattern 2” is applied to the operation item of the keyboard; and the display area and the operation area are arranged vertically in the display screen, so that a user can operate the keyboard without feeling discomfort.

In this manner, by defining the area layout depending on the kind of an operation item, and by operating an operation item arranged in the operation area, a user can operate the numeric keypad and the keyboard as they were physical keys without feeling discomfort.

Returning to FIG. 4, the display area standard size is a standard size of the display area. The display area standard size is not a size relative to a screen size, but a size specified by an absolute value. The operation area minimum size is a minimum size of the operation area. Similarly to the display area standard size, the operation area minimum size is a size specified by an absolute value.

In the embodiment, in a web page for document size setting, the operation area minimum size is associated with the width of one button of the numeric keypad, for example. In a web page for document storage, the operation area minimum size is associated with the length of one row of the keyboard.

For example, when the numeric keypad of “pattern 1” is displayed in the operation area minimum size, the buttons of the numeric keypad arranged in a single column are displayed, and the rest of the buttons of the keypad are displayed with scrolling operation. When the keyboard of “pattern 2” is displayed in the operation area minimum size, the keys arranged in a single row are displayed, and the rest of the keys are displayed with scrolling operation.

Thus, in the embodiment, the operation area minimum size is defined regarding either a vertical size or a lateral size thereof. Here, the size of one button of the numeric keypad and the size of one row of the keyboard are set preliminarily with absolute values, respectively.

Returning to FIG. 1, the system control unit 132 controls the entire state of the image forming apparatus 10. The memory control unit 133 controls memory, and generates file data through scanning by the scanner 137, which is described later. The engine control unit 134 controls scanning and printing documents. The user control unit 135 performs user authentication, and controls scanner destinations. The plotter 136 is a device that performs printing. The scanner 137 is a device that performs scanning. The API 140 is an interface between the copy application 130 and the scanner application 131 and the system control unit 132, the memory control unit 133, the engine control unit 134, and the user control unit 135.

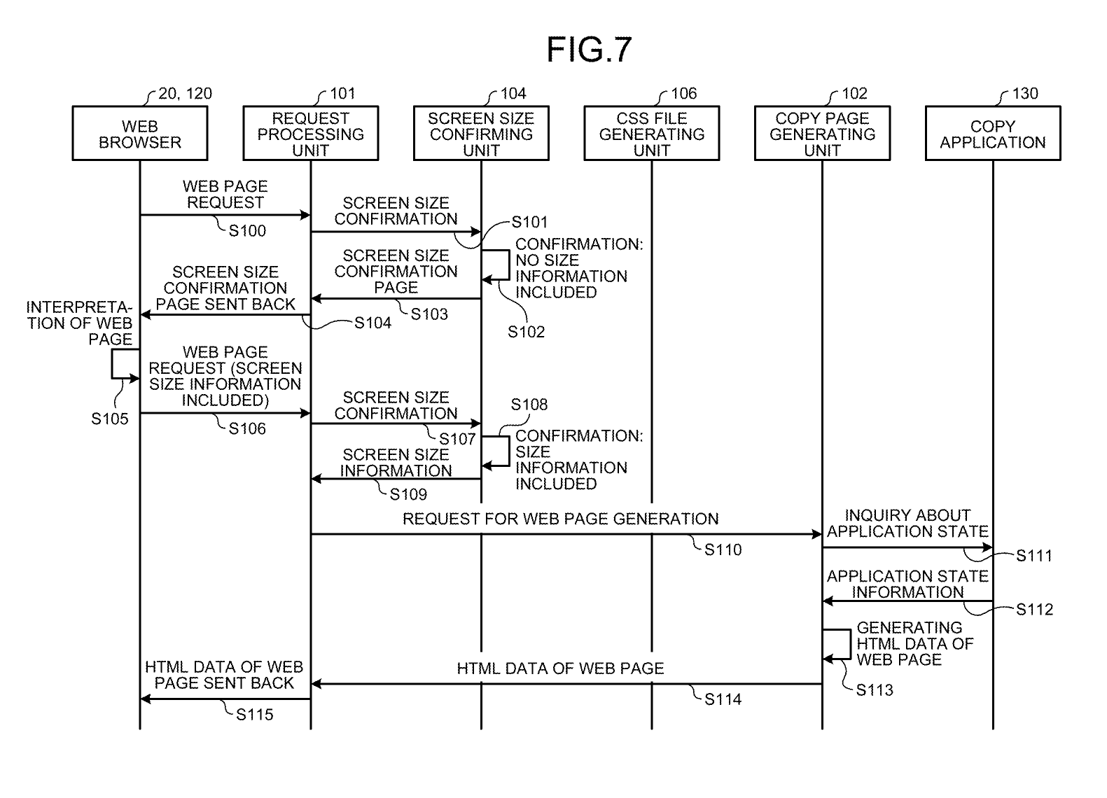

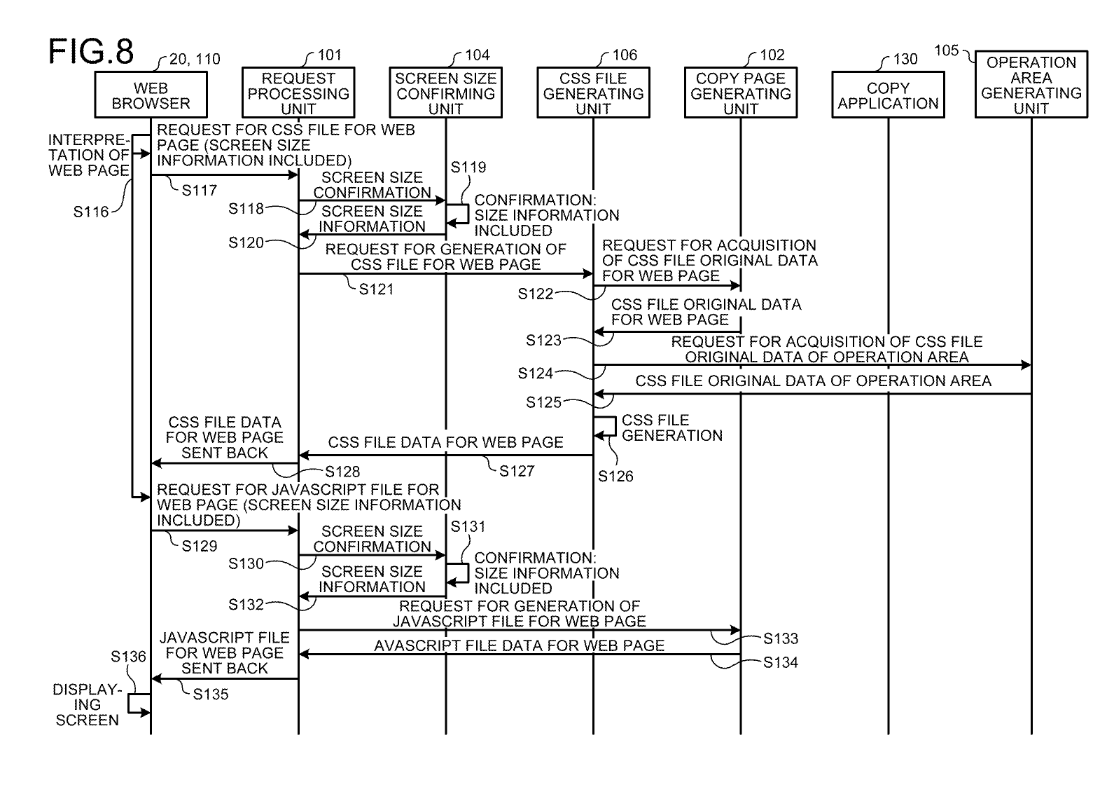

FIG. 7 and FIG. 8 are sequence diagrams illustrating processing of the image forming system 1 when a web page display request is transmitted from the operation terminal 20 or the operation display panel 120 as a web browser to the web server 100. FIG. 7 and FIG. 8 illustrate processing of the image forming system 1 in a case where a request for display of a web page related to an application is transmitted, for example.

As illustrated in FIG. 7, a web page request (display request) is transmitted from the operation terminal 20 or the operation display panel 120 as a web browser (Step S100); and the request processing unit 101 of the web server 100 acquires the request.

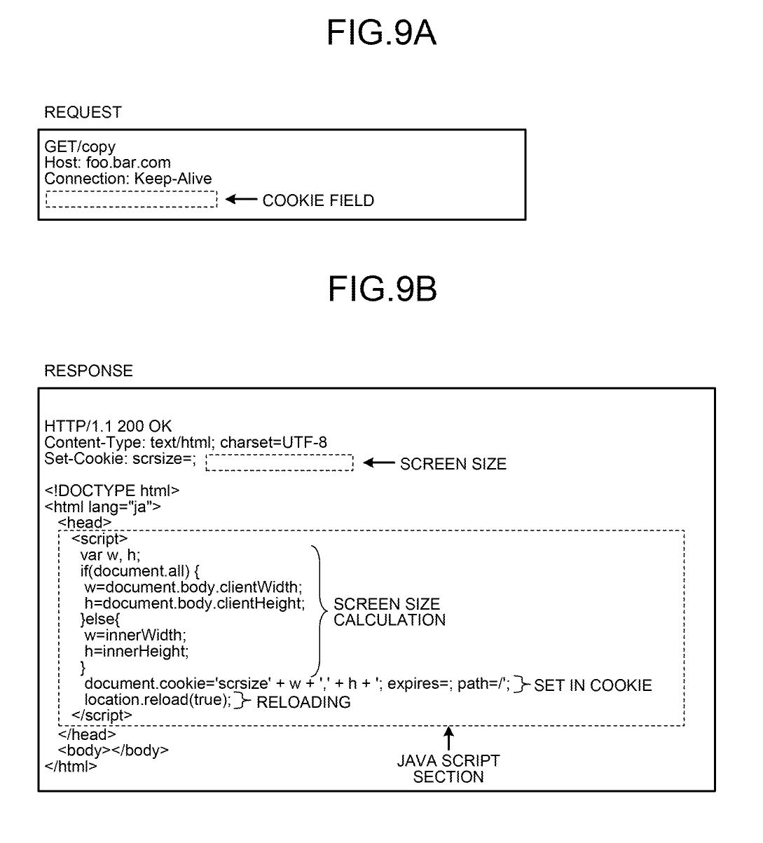

FIG. 9A is a diagram illustrating an HTTP request transmitted from the web browser at Step S100. A cookie field of the request header of the HTTP request does not include the information of a screen size of an apparatus as a sender of the request.

Acquiring the HTTP request illustrated in FIG. 9A, the request processing unit 101 sends an inquiry about screen size confirmation to the screen size confirming unit 104 (Step S101). Once the screen size confirming unit 104 confirms that screen size information is not included in the cookie field of the HTTP request (Step S102), it sends web page data for confirming a screen size (screen size confirmation page) back to the request processing unit 101 (Step S103). The request processing unit 101 sends the screen size confirmation page acquired at S103, as a response to the request for a page for document storage, back to the web browser as a sender of the display request (Step S104).

FIG. 9B is a diagram illustrating a screen size confirmation page sent back to the web browser at S104. In the screen size confirmation page, a field of the screen size in a cookie is blank as illustrated in FIG. 9B. The screen size confirmation page includes a JavaScript section. The JavaScript section describes processing for calculating a screen size and setting the screen size in the coolie field.

Returning to FIG. 7, once the web browser acquires the screen size confirmation page, it interprets the screen size confirmation page, and executes the JavaScript section (see FIG. 9B) described in the screen size confirmation page (Step S105). With execution of the JavaScript section, the screen size information of the display screen is set in the cookie; and a web page request is transmitted again from the web browser to the web server 100 (Step S106). The web page request transmitted at S106 includes screen size information.

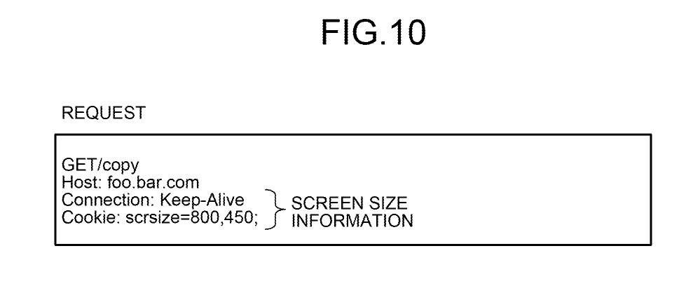

FIG. 10 is a diagram illustrating a request transmitted from the web browser at S106. As illustrated in FIG. 10, the web page request transmitted at S106 includes the screen size information set in the cookie field.

Returning to FIG. 7, once the request processing unit 101 acquires the web page request (Step S106), it sends again an inquiry about screen size confirmation to the screen size confirming unit 104 (Step S107). Confirming that the screen size information is included in the cookie field of the request (Step S108), the screen size confirming unit 104 sends the screen size information included in the cookie field back to the request processing unit 101 (Step S109). Acquiring the screen size information, the request processing unit 101 transmits a web page generation request to the copy page generating unit 102 (Step S110).

The copy page generating unit 102 sends an inquiry about the current state of the copy application 130 (application state) to the copy application 130 (Step S111). Here, the application state includes information of whether the copy can be performed, which tray is selected as a paper cassette, etc. The information related to the inquiry is information of the application state to be displayed in a web page among other application states. Once the copy page generating unit 102 acquires the information of the application state from the copy application 130 (Step S112), it refers to the application state to generate HTML data of a web page (Step S113). Then, the copy page generating unit 102 sends the generated web page HTML data back to the request processing unit 101 (Step S114).

Acquiring the web page HTML data, the request processing unit 101 sends it, as a response to the request acquired from the web browser at S106, back to the web browser (Step S115).

The HTML data sent back at S115 includes description of a reading instruction on a CSS file or a JavaScript file, which is processing described later, display areas included in the web page, items to be arranged in each of the display areas, etc. Note that the HTML data does not define the information of whether there is an operation area, the sizes of a display area and an operation area, the area layout, etc.

Acquiring the web page HTML data (Step S115) (see FIG. 7), the web browser then interprets the HTML data acquired from the web browser (Step S116), and sends, based on the CSS file reading instruction that is described in the HTML data, a request for a CSS file for web page of the display request to the web server 100 (Step S117), as illustrated in FIG. 8.

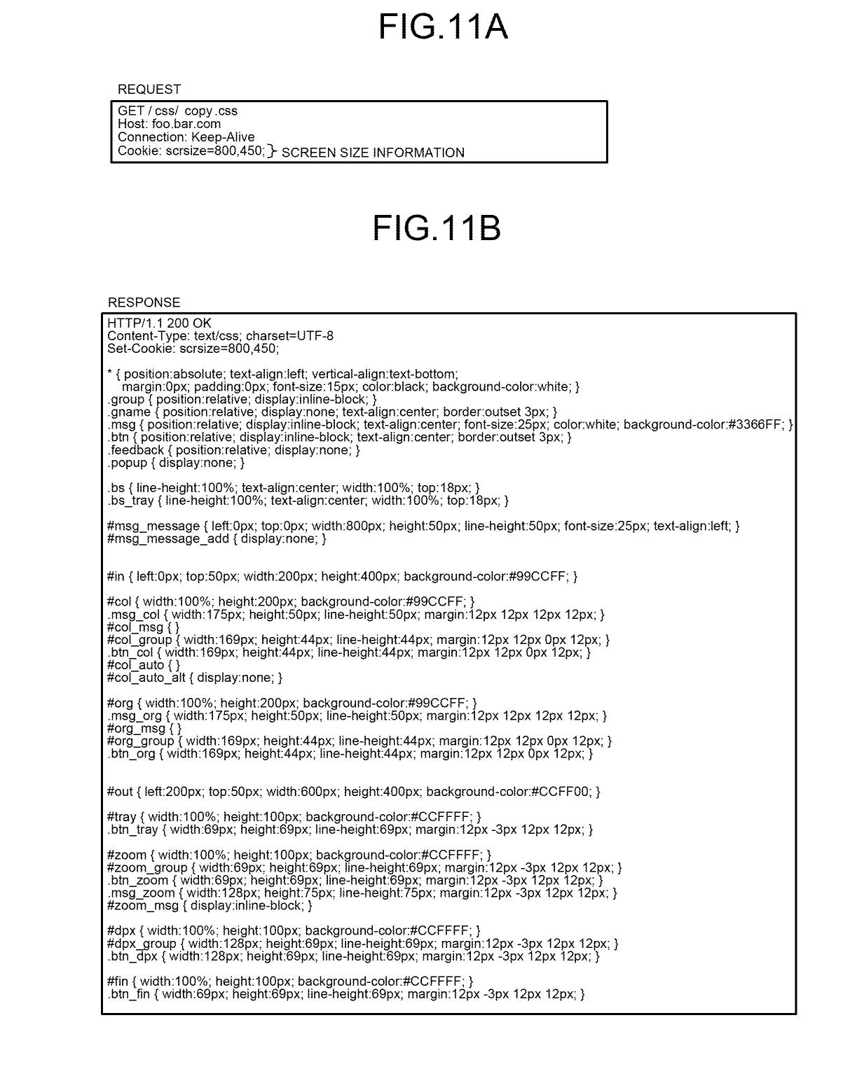

FIG. 11A is a diagram illustrating a request transmitted from the web browser at S117. As illustrated, the request transmitted at S117 includes the screen size information set in the cookie field.

Returning to FIG. 8, the request processing unit 101 sends an inquiry about screen size confirmation to the screen size confirming unit 104 (Step S118). Confirming that the screen size information is included in the cookie field (Step S119), the screen size confirming unit 104 sends the screen size information back to the request processing unit 101 (Step S120).

Once the request processing unit 101 acquires the screen size information, it transmits a request for generation of a CSS file for web page to the CSS file generating unit 106 (Step S121). The CSS file generating unit 106 transmits a request for acquisition of CSS file original data for web page to a page generating unit of the copy page generating unit 102 or the scanner page generating unit 103 that corresponds to a web page of the generation request (Step S122). In the example illustrated in FIG. 8, the web page of the display request is related to the copy application 130. Thus, the CSS file generating unit 106 transmits the request for acquisition of CSS file original data to the copy page generating unit 102. The copy page generating unit 102 sends the CSS file original data for web page back to the CSS file generating unit 106 in response to the acquisition request (Step S123).

The CSS file generating unit 106 further transmits a request for acquisition of CSS file original data of an operation area to the operation area generating unit 105 (Step S124). The operation area generating unit 105 sends the CSS file original data of the operation area corresponding to the web page of the display request back to the CSS file generating unit 106 in response to the acquisition request (Step S125).

Next, the CSS file generating unit 106 refers to the rule table 112 based on the CSS file original data for web page, the CSS file original data of the operation area, and the screen size, so as to generate a CSS file for web page (Step S126). Note that the processing of generating CSS file data is described later.

The CSS file generating unit 106 sends the CSS file data for web page back to the request processing unit 101 (Step S127). The request processing unit 101 sends the CSS file data for web page, as a response to the request from the web browser at S117, back to the web browser (Step S128).

FIG. 11B is a diagram illustrating an example of the CSS file data for web page sent back to the web browser at S128. The CSS file data for web page illustrated in FIG. 11B defines the information of whether there is an operation area, the sizes of a display area and an operation area, the area layout, etc.

Returning to FIG. 8, the web browser sends a request for a JavaScript file for web page to the web server 100 based on the JavaScript file reading instruction described in the HTML data obtained at Step S115 (Step S129).

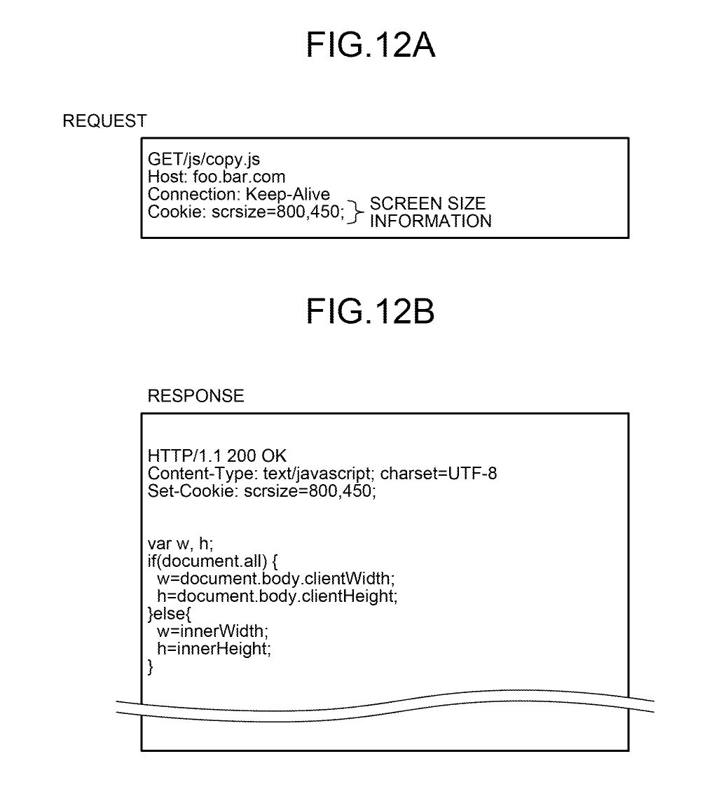

FIG. 12A is a diagram illustrating the request transmitted from the web browser at Step S129. As illustrated in FIG. 12A, a cookie field of the request transmitted at S129 includes the screen size information set.

Returning to FIG. 8, the request processing unit 101 sends an inquiry about screen size confirmation to the screen size confirming unit 104 (Step S130). Confirming that the screen size information is included in the cookie field (Step S131), the screen size confirming unit 104 sends the screen size information back to the request processing unit 101 (Step S132).

Once the request processing unit 101 acquires the screen size information, it transmits a request for generation of a JavaScript file for web page to the copy page generating unit 102 (Step S133). The copy page generating unit 102 sends the preliminarily-stored JavaScript file data for web page to the request processing unit 101 (Step S134). It is assumed that JavaScript files for web page are generated by a creator of web pages, and preliminarily stored in the copy page generating unit 102.

The request processing unit 101 sends the JavaScript file for web page, as a response to the request from the web browser at S129, back to the web browser (Step S135). FIG. 12B is a diagram illustrating the JavaScript file for web page sent back to the web browser at S135.

The web browser displays the JavaScript file for web page acquired at S135 on the display screen (Step S136). Here, the processing of the image forming system 1 is completed.

As another example, it is possible to preliminary set such that the web page request transmitted from the operation display panel 120 always includes a screen size. In this case, when the web browser is the operation display panel 120, a web page can be displayed with processing at S106 and the processing following it, omitting the processing at S100 to S105, which has been described with reference to FIG. 7.

The web server 100 of the embodiment generates the HTML data defining display contents of a web page, and the CSS file defining the layout of the HTML data, etc. However, the data format for defining the display contents and the layout, etc. of a web page, is not limited to those described in the embodiment; and the display contents and the layout of a web page may be defined using other data format.

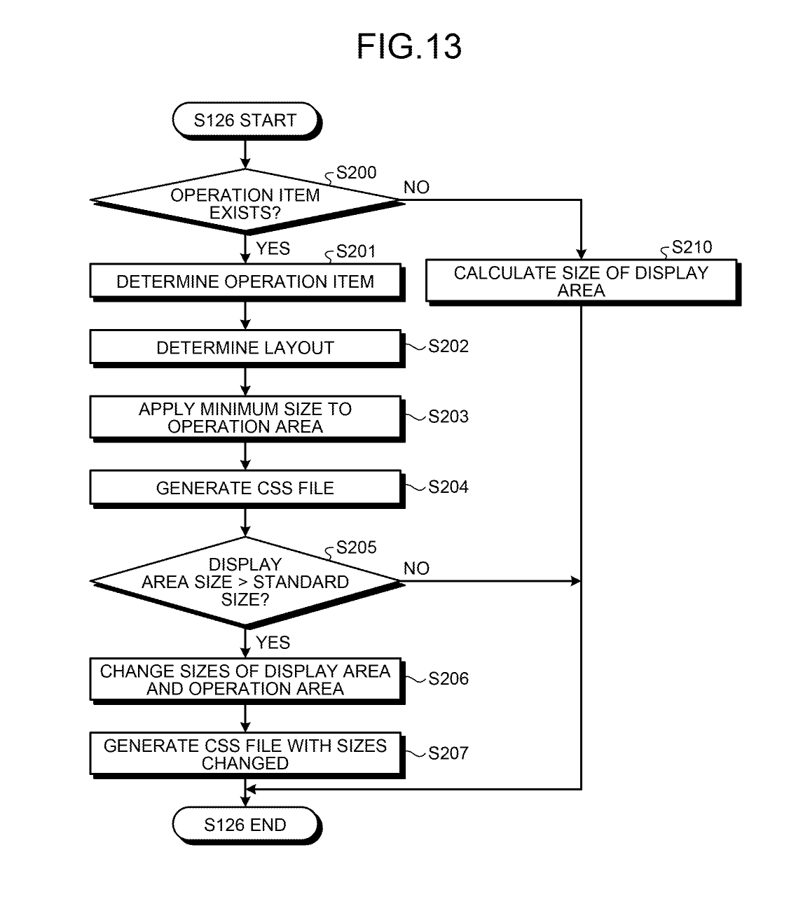

FIG. 13 is a flowchart illustrating specific processing of the CSS file generating unit 106 in CSS file generation processing (Step S126). In CSS file generation processing (Step S126), the operation item determining unit 107 of the CSS file generating unit 106 refers to the rule table 112 so as to confirm whether there is an operation item associated with the type of a web page of the display request. When there is an operation item associated with the type of a web page (Yes at Step S200), the operation item determining unit 107 determines the associated operation item as an operation item to be displayed on a web page (Step S201).

Next, the layout determining unit 108 refers to the rule table 112 to determine the area layout associated with the type of the web page as an area layout of a web page to be generated (Step S202).

Subsequently, the size determining unit 109 applies an operation area minimum size stored in the rule table 112 to the operation area (Step S203), and generates a CSS file defining the rest of the screen area as a display area based on the screen size (Step S204).

Next, when the size of the display area is larger than the display area standard size stored in the rule table 112 in the layout of the CSS file generated at S203 (Yes at Step S205), the size determining unit 109 changes the sizes of the display area and the operation area so that the size of the display area is reduced to the standard size and the operation area is enlarged by a reduced amount of the display area (Step S206), and generates a CSS file with area sizes changed (Step S207).

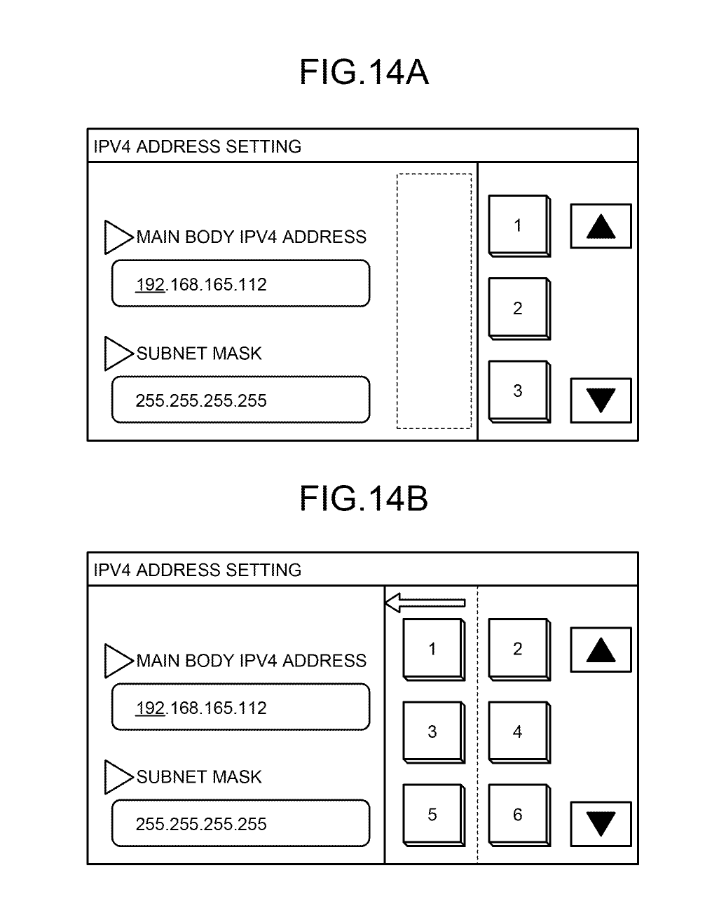

FIG. 14A is a diagram illustrating an example of the layout of the CSS file generated at Step S204. When there is a blank space in the display area, as illustrated in FIG. 14A, the sizes of the operation area and the display area are changed at Step S206 so that the operation area is enlarged, as illustrated in FIG. 14B.

In this manner, it is possible, in the screen layout, to secure an area with a size as close to a standard size as possible for the display area while securing an area with a minimum size for the operation area.

In the embodiment, the size of the display area is determined after the minimum size of the operation area is secured. However, it is possible, as another example, to arrange such that the minimum size of the display area is preliminarily set in the rule table 112 and the operation area size is determined after the minimum size of the display area is secured. Thus, it is possible to set preliminarily and arbitrarily the size of each area and which size is preferentially determined.

At Step S200, when no operation item is associated with the type of a web page in the rule table 112 (No at Step S200), the layout determining unit 108 determines to display only a message area and a display area on a web page, and the size determining unit 109 calculates the size of the display area in accordance with the screen size (Step S210).

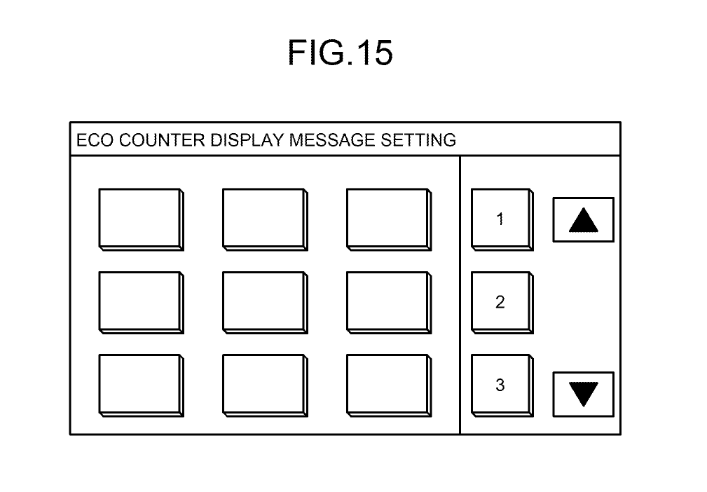

FIG. 15 is a diagram illustrating another example of the layout of the CSS file generated at S204. When there is no blank space in the display layout, as illustrated in FIG. 15, the sizes of the display area and the operation area are determined based on the CSS file generated at Step S204; and the recalculation of the sizes at S206 is not performed.

When the display area size is smaller than a standard size at Step S205 (No at Step S205), the processing is finished. Here, the CSS file generation processing (Step S126) is completed.

For example, when a web page of the display request is the page for document storage 300, the keyboard 331 is determined as an operation item, and the pattern 2 is determined as an area layout. Thus, the layout determined as illustrated in FIG. 3 in which the display area and the operation area are arranged vertically in the display screen.

Regarding the size of the display area of a page for document storage, the width is determined to be the same as the screen size based on the definition of the rule table 112; and the height is determined to be a value of one fourth of a value obtained by deducting the height of the message area from the screen size based on the definition of the rule table 112. Regarding the size of the operation area of a page for document storage, the width is determined to be the same as the screen size based on the definition of the rule table 112; and the height is determined to be a value of three fourth of a value obtained by deducting the height of the message area from the screen size based on the definition of the rule table 112.

In this manner, in the image forming system 1 of the embodiment, the arrangement position and the size of the operation area in which the operation item is displayed are defined for each type of a web page. Thus, the web server 100 can generate a web page in which an operation area with a size in accordance with the size of the web page is arranged at an appropriate position.

### Second Embodiment

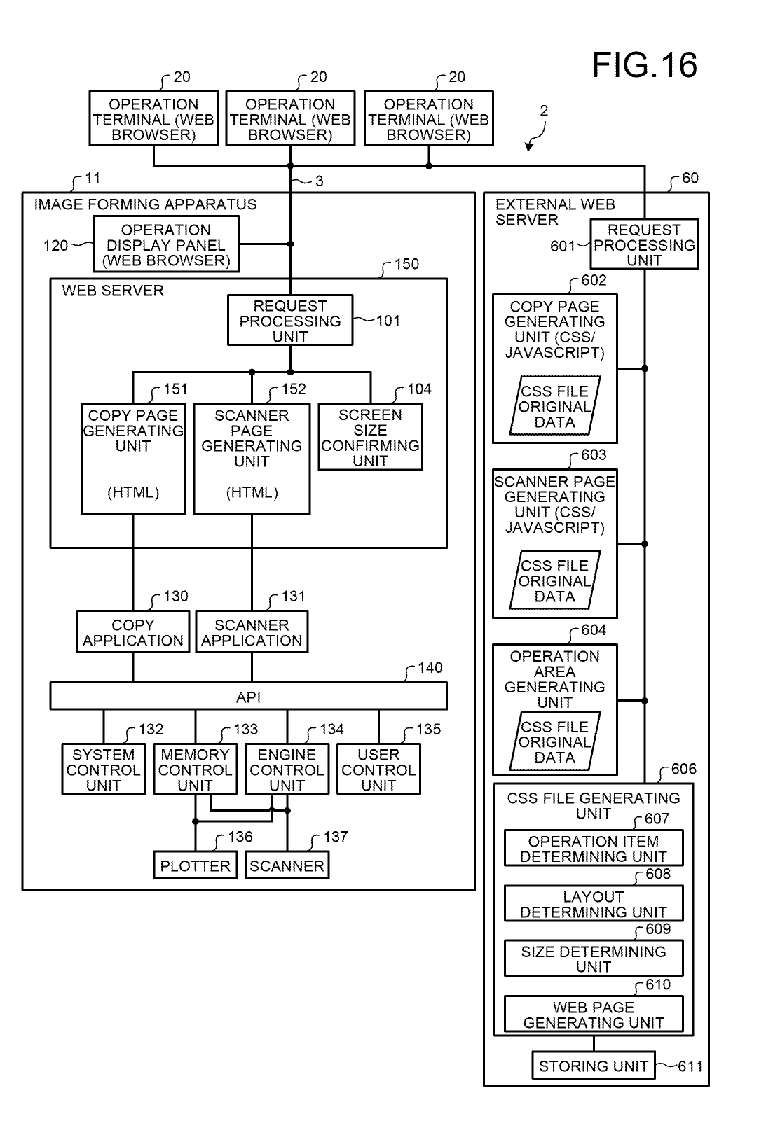

FIG. 16 is a diagram illustrating an entire configuration of an image forming system 2 of a second embodiment. The image forming system 2 has an image forming apparatus 11, the operation terminals 20, and an external web server 60 connected to them through the network 3. A copy page generating unit 151 and a scanner page generating unit 152 of a web server 150 of the image forming apparatus 11 generate web page HTML data.

The external web server 60 has a request processing unit 601, a copy page generating unit 602, a scanner page generating unit 603, an operation area generating unit 604, a CSS file generating unit 606, and a storage unit 611. The CSS file generating unit 606 has an operation item determining unit 607, a layout determining unit 608, a size determining unit 609, and a web page generating unit 610.

The request processing unit 601 acquires, from the operation terminal 20 or the operation display panel 120, a request such as a display request corresponding to the information input by a user on the operation terminal 20 or the operation display panel 120. The request processing unit 601 refers to a URL in the request, and instructs, depending on the URL, any of the copy page generating unit 602, the scanner page generating unit 603, the operation area generating unit 604, and the CSS file generating unit 606 of the external web server 60 to perform processing in accordance with the request.

The copy page generating unit 602 and the scanner page generating unit 603 both have CSS file original data. The copy page generating unit 602 and the scanner page generating unit 603 generate CSS files and transmit JavaScript files.

That is, in the image forming system 2 of the second embodiment, the processing at Step S100 to Step S115 of the first embodiment, which has been described with reference to FIG. 7, is performed by the web server 150; and the processing at Step S117 to Step S135 thereof, which has been described with reference to FIG. 8, is performed by the external web server 60.

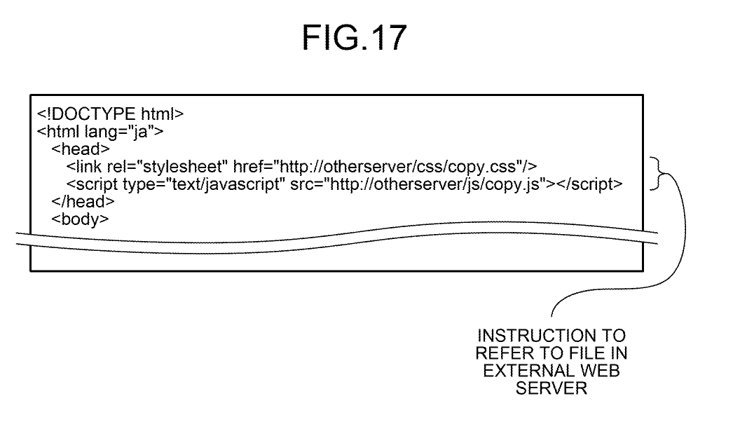

FIG. 17 is a diagram illustrating an example of the HTML data generated by the copy page generating unit 151 of the image forming apparatus 11. As illustrated in FIG. 17, the HTML data includes description of an instruction to refer to a file in the external web server 60. Thus, the web browser can transmit a request to the external web server 60 at Step S117 and Step S129 illustrated in FIG. 8.

In this manner, in the image forming system 2 of the second embodiment, the image forming apparatus 11 only generates HTML data; and the external web server 60 generates a CSS file and a JavaScript that are related to the layout of a web page. Thus, even when a web page for a new screen size needs to be generated, for example, only the change of software of the external web server 60 is required without the change of software of the web server 150 of the image forming apparatus 11.

Regarding the image forming system 2 of the second embodiment, the configuration and processing other than those described above are the same as of the image forming system 1 of the first embodiment.

A program executed in the image forming apparatuses of the embodiments is preliminarily embedded in a read only memory (ROM), etc., to be provided. The program executed in the image forming apparatuses of the embodiments may be recorded, as a file whose format is installable or executable, in a computer readable recording medium such as a compact disk read only memory (CD-ROM), a flexible disk (FD), a compact disk recordable (CD-R), and a digital versatile disk (DVD), to be provided.

The program executed in the image forming apparatuses of the embodiments may be stored in a computer connected to a network such as the Internet, and then provided by download thereof through the network. Alternatively, the program executed in the image forming apparatuses of the embodiments may be provided or distributed through a network such as the Internet.

The program executed in the image forming apparatuses of the embodiments is of module configuration including the units described above (request processing unit, copy page generating unit, scanner page generating unit, screen size confirming unit, operation area generating unit, and CSS file generating unit). As actual hardware, the CPU (processor) reads out the program from the ROM and executes it, so that the above-mentioned each unit is loaded into a main memory, and generated on the main memory.

The image forming apparatus of the embodiment can be applied to any image forming apparatus having at least two functions among a copy function, a printer function, a scanner function, and a facsimile function, such as an MFP, a copying machine, a printer, a scanner, and a facsimile.

The embodiments exert effect of displaying display information excellent in operability and visibility on a display device regardless of the screen size of the display device.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A display control device, comprising:
an acquiring unit that acquires a request for display of display information regarding an apparatus on a display screen;
an operation item determining unit that determines, based on a type of the display information, a kind of an operation item that receives user operation while the display information is displayed;
an arrangement determining unit that determines, based on the determined kind of the operation item, arrangement positions of
an operation area in which the operation item is displayed and
a display area in which the display information is displayed in the display screen;
a size determining unit that determines, based on the arrangement positions and a screen size of the display screen, sizes of the operation area and the display area; and
a display information generating unit that generates display information including the operation area and the display area having the sizes determined.

2. The display control device according to claim 1, wherein
the acquiring unit further acquires the screen size of the display screen, and
the size determining unit determines, based on the arrangement positions and the screen size acquired by the acquiring unit, sizes of the operation area and the display area.

3. The display control device according to claim further comprising:
a first storage unit that stores therein the kind of the operation item and the arrangement positions in an associated manner, wherein
the arrangement position determining unit refers to the first storage unit so as to determine the arrangement positions of the operation area and the display area.

4. The display control device according to claim 1, further comprising:
a second storage unit that stores therein the kind of the operation item and
size determination information that determines the sizes of the operation area and the display area based on the screen size in an associated manner, wherein
the size determining unit refers to the second storage unit so as to determine, based on the screen size, size of the operation area and size of the display area.

5. A display control method performed by a display control device, the display control method comprising:
acquiring a request for display of display information regarding an apparatus on a display screen;
determining, based on a type of the display information, a kind of an operation item that receives user operation while the display information is displayed;
determining, based on the determined kind of the operation item, arrangement positions of
an operation area in which the operation item is displayed and
a display area in which the display information is displayed in the display screen;
determining, based on the arrangement positions and a screen size of the display screen, sizes of the operation area and the display area; and
generating display information including the operation area and the display area having the sizes determined.

6. A computer program product comprising a non-transitory usable medium having computer-readable program codes embodied in the medium for display control in a display control device, the program codes when executed causing the display control device to execute:
acquiring a request for display of display information regarding an apparatus on a display screen;
determining, based on a type of the display information, a kind of an operation item that receives user operation while the display information is displayed;
determining, based on the determined kind of the operation item, arrangement positions of
an operation area in which the operation item is displayed and
a display area in which the display information is displayed in the display screen;
determining, based on the arrangement positions and a screen size of the display screen, sizes of the operation area and the display area; and
generating display information including the operation area and the display area having the sizes determined.
